(19) United States
(12) Patent Application Publication
(10) Pub. No.: US 2025/0283352 A1
(43) Pub. Date: Sep. 11, 2025

(54) CLEAN ROOM MODULE, CLEAN ROOM SYSTEM AND SELF-LOCKING METHOD OF CLEAN ROOM MODULE

(71) Applicant: Precison Robotics (Hong Kong) Limited, Shatin, N.T. (HK)

(72) Inventors: Ho Chi Wong, Shatin, N.T. (HK); Ka Wai Chan, Shatin, N.T. (HK); Tak Man Leung, Shatin, N.T. (HK); Lap Fung Chan, Shatin, N.T. (HK); Fei Long Chen, Shatin, N.T. (HK)

(21) Appl. No.: 18/571,415

(22) PCT Filed: May 27, 2022
(86) PCT No.: PCT/CN2022/095402

§ 371 Date: Dec. 18, 2023

(30) Foreign Application Priority Data
Jun. 16, 2021 (HK) 22021033217.1

(51) Int. Cl. E05B 47/00; E05F 15/75; F24F 3/167

(52) U.S. Cl. CPC E05B 47/00; E05F 15/75; F24F 3/167; E05Y 2900/148; F24F 2221/36

(57) ABSTRACT

A clean room module, a clean room system, and a self-locking method of the clean room module are provided. The clean room module includes: a housing provided with a sealing window, around which is arranged a seal; an automatic switching device connected with the sealing window to control opening and closing of the sealing window; a self-locking device provided at the housing and located on the side of the sealing window, wherein the self-locking device can be connected to and locked with a self-locking device of another clean room module from outside. When the self-locking device is locked: the seal forms a sealed contact with a seal of another clean room module; the clean room module sends a locking signal to a controller; and the automatic switching device opens the sealing window responsive to a window opening signal generated by the controller according to the locking signal.

### CROSS-REFERENCE TO RELATED APPLICATIONS

This Application is a National Stage Application under 35 U.S.C. §371 of PCT Application No. PCT/CN2022/095402, filed May 27, 2022 which claims priority to Hong Kong patent application Ser. No. 20/221,033217.1, filed Jun. 16, 2021, the entire contents of which are incorporated by reference herein.

### TECHNICAL FIELD

The present application relates to the technical field of clean room, in particular to a clean room module, a clean room system, and a self-locking method of the clean room module.

### BACKGROUND OF THE INVENTION

A clean room refers to a well-sealed space in which air cleanliness, temperature, humidity, pressure, noise and other parameters are controlled as required.

The development of clean room is closely associated with modern industry and cutting-edge technology. Since precision machinery, semiconductors, pharmaceuticals, aerospace and medical industries have high requirements for the environment, the technology of clean room has been continuously developed and widely used in the foregoing fields.

On the other hand, high mobility of the industries is a new growing trend for the keen of competition market. Traditional clean room is fixed in the factory building. When encountering various kinds of events such as the introduction of new processes, roll-out of new product lines, iterative upgrade of factory functions, and addition of new equipment, the change of production lines will be involved. During the process of changing, it is inevitably necessary to disassemble and relocate the clean room. Therefore, the clean room of the prior art involves a high cost and a long installation time during the relocation process.

### SUMMARY OF THE INVENTION

In order to solve or at least partially solve the technical problems stated above, the present application provides a clean room module, a clean room system, and a self-locking method of the clean room module.

Among them, the clean room module comprises: a housing provided with a sealing window around which is arranged a seal; an automatic switching device connected with the sealing window to control the opening and closing of the sealing window; a self-locking device provided at the housing and located on the side of the sealing window, wherein the self-locking device can be connected to and locked with a self-locking device of another clean room module from outside; while the self-locking device is locked, the seal forms a sealed contact with a seal of another clean room module; when the self-locking device is locked, the clean room module sends a locking signal to a controller, and the automatic switching device opens the sealing window responsive to a window opening signal generated by the controller according to the locking signal.

The present application also provides a clean room system that is provided with a plurality of the foregoing clean room modules, the respective clean room modules being connectable to each other via the automatic switching device.

The present application also provides a self-locking method of clean room module, which comprises the steps of: sending a locking signal to a controller, responsive to a locking operation of a self-locking device of the clean room module with a self-locking device of another clean room module from outside; opening a sealing window of the clean room module with an automatic switching device, responsive to a window opening signal generated by the controller according to the locking signal.

The clean room provided according to the embodiments of the present application replaces traditional self-contained clean room with a modular approach, and can realize rapid disassembly and relocation in case the production lines need to be changed. Accordingly, compared with the prior art, the clean room system of the present application involves better convenience, reliability and sealing stability.

### BRIEF DESCRIPTION OF THE DRAWINGS

To better explain embodiments of the present application, relevant drawings will be briefly described below. It is to be understood that, drawings described below are only used to illustrate certain embodiments of the present application, and those of ordinary skill in the art can perceive many other technical features and connections not mentioned herein, based on these drawings.

FIG. 1 is a perspective schematic view of a clean room module according to an embodiment of the present application;

FIG. 2 is a perspective schematic view of a clean room system according to an embodiment of the present application;

FIG. 3 is a partial schematic view of a sealing window in a clean room module according to an embodiment of the present application;

FIG. 4 is a partial schematic view of a first locking part in a clean room module according to an embodiment of the present application;

FIG. 5 is a partial schematic view of a second locking part in a clean room module according to an embodiment of the present application;

FIG. 6 is a partial schematic view of a clean room module in an embodiment of the present application when the first locking part is locked with the second locking part.

### REFERENCE SIGNS

100. clean room module; 1. housing; 2. sealing window; 3. seal; 4. self-locking device; 41. first locking part; 42. second locking part; 43. third locking part; 5. automatic switching device.

### DETAILED DESCRIPTION OF EMBODIMENTS

The application will be described in detail below in conjunction with the drawings.

A Chinese patent for invention No. CN 111809938A entitled “a modular clean laboratory”, and a Chinese utility model No. CN 211646785U entitled “a modular clean room” are found in the prior art. In these two prior arts, bolt assembly and metal plate fixing block are respectively used to perform fixing among the respective modules. However, the disassembly and assembly processes in these such ways are very cumbersome, and cannot satisfy the requirements for rapid iteration in the process of technological evolution.

In view of this, the embodiments of the present application proposes a clean room module, a clean room system, and a self-locking method of the clean room module.

### First Embodiment

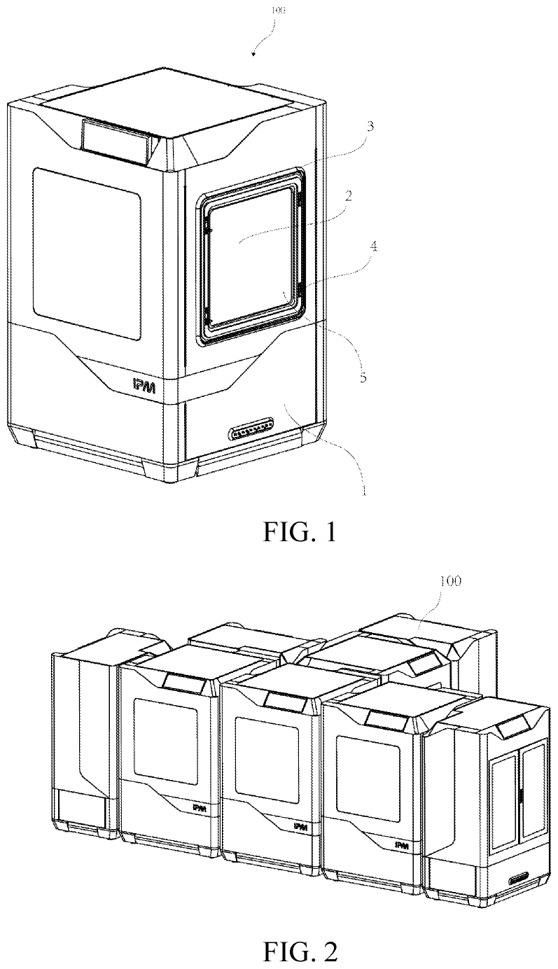

The first embodiment of the present application proposes a clean room module 100, as shown in FIG. 1, which comprises a housing 1 provided with a sealing window 2, around which is arranged a seal 3. Typically, in order to obtain the most reasonable space utilization rate, the clean room module 100 constrained by the housing 1 may be in the shape of regular polyhedron, particularly a rectangular frame shown in FIG. 1. Thereby, the sealing window 2 can be arranged on each surface of the housing 1 perpendicular to the bottom surface thereof.

The content arranged inside the housing 1 is a functional content of the clean room module 100. For example, a centrifugal granulation apparatus can be installed in an existing clean room module 100, and the granulated product can be transported to the vicinity of the sealing window 2 through a conveyor belt. A conveyor belt is also installed in the next clean room module 100, and a pressure device is installed at the terminal end of the conveyor belt to press the granulated product into a mold shape. Furthermore, the central clean room module 100 can also be provided with a robotic arm, and multiple peripheral clean room modules 100 are connected to the central clean room module 100 from multiple directions, and robotic arms are used to perform assembly operations of product. The clean room system assembled by the clean room modules 100 may have many functions, which will not be repeated here.

An automatic switching device 5 is connected with the sealing window 2 to control opening and closing of the sealing window 2. The automatic switching device 5 can be implemented in a plurality of ways for opening and closing the doors and windows in the prior art. For example, an air rod or a motor can be used as a power source to push or rotate the sealing window 2 so as to open or close the sealing window 2.

A self-locking device 4 is arranged on the housing 1 and located on the side of the sealing window 2. The self-locking device 4 can be connected to and locked with the self-locking device 4 of another clean room module 100 from outside. When the self-locking device 4 is locked, the seal 3 forms a sealed contact with the seal 3 of another clean room module 100. For the clean room module 100 of the present application, the seal 3 adopted may be a rubber ring surrounding outer circumference of the sealing window 2. The rubber ring can be provided with grooves and ribs, and the grooves and ribs of the seals 3 between two different clean room modules 100 can be matched with each other to obtain a better sealing effect. Through the sealed contact between the seals 3, a sealed channel between two clean room modules 100 can be established. When the self-locking device 4 is locked, the clean room module 100 may send a locking signal to a controller, and the automatic switching device 5 can open the sealing window 2 responsive to a window opening signal generated by the controller according to the locking signal.

Among them, the self-locking device 4 may adopt various electronic locks or mechanical locks in the prior art. As an example of the mechanical lock, a lock tongue can be provided on one clean room module 100, and a spring lock groove can be provided on another clean room module 100. When the two are approaching, the lock tongue is inserted into the spring lock groove, and the lock tongue is locked by the spring in the spring lock groove. Alternatively, the self-locking device 4 may be provided in an area between the sealing window 2 and the seal 3. In this case, the distance from the sealing window 2 and seal 3 is smaller, so the self-locking device 4 arranged in this way can reduce an adverse effect that the housing 1 may have on the sealing due to the deformation from force.

In addition, it is understood that, the controller in the present application may be separately arranged in the respective clean room modules 100, and independently control the clean room module 100 where it is located. At this time, the clean room module 100 includes a controller. Alternatively, the controller may be arranged in a control hub other than the clean room module 100, to control all the clean room modules 100 in the site in a coordinated manner.

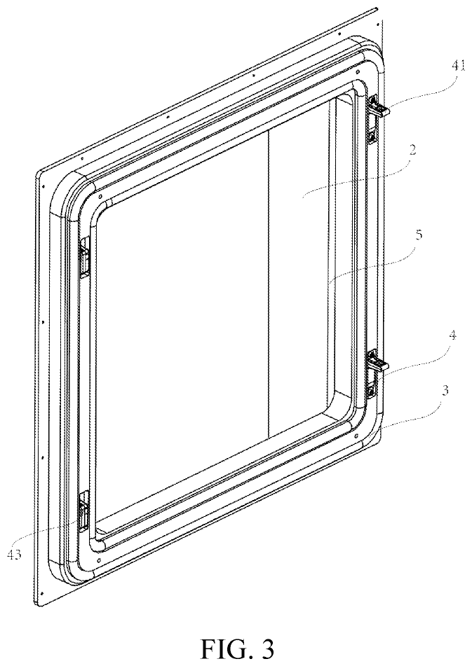

According to the above solutions, the present application also proposes a clean room system. As shown in FIG. 2, a plurality of the aforementioned clean room modules 100 are provided in this system, and the respective clean room modules 100 are connectable to each other via an automatic switching device 5.

And, the present application also proposes a self-locking method of clean room module, which comprises the steps of: sending a locking signal to a controller, responsive to a locking operation of the self-locking device 4 with a self-locking device 4 of another clean room module 100 from outside; opening a sealing window 2 with an automatic switching device 5, responsive to a window opening signal generated by the controller according to the locking signal.

The clean room module 100 can be moved through manual pushing, or it can be arranged on a guide rail to be moved by a device, or even it can be equipped with a driving wheel to be moved through a remote control or an AI control. When two clean room modules 100 are approaching, the self-locking devices 4 are relatively close to each other, and will lock with each other when a critical distance is exceeded. Optionally, an alignment sensor, such as an infrared or laser sensor, may be provided on the housing 1 of the clean room module 100, to ensure that multiple clean room modules 100 are opposed to each other in a correct position. When the two are locked, the controller can receive a locking signal. This locking signal can be sent by the self-locking device 4 itself, or by a means installed on the self-locking device 4, e.g., a trigger switch, sensor, etc.

Once the controller has received the locking signal, it can send out a window opening signal immediately, or it can delay a certain time to ensure that locking action of the self-locking device 4 has been completely finished before sending it out. The specific timing of sending the window opening signal can be determined according to the type of self-locking device 4 adopted.

In contrast when the respective clean room modules 100 need to be separated, the controller can send a separation signal. At this time, the system can sequentially perform the following operations responsive to the separation signal sent by the controller: closing the sealing window 2 with the automatic switching device 5; releasing the locked state of the self-locking device 4.

The above sequence of operations for releasing the self-locking device 4 is opposite to the sequence of operations for locking the self-locking device 4, which can ensure that the sealing window 2 can always be kept closed while the self-locking device 4 is not in the locked state.

Notably, the locked state of the self-locking device 4 can be automatically released only when the self-locking device 4 itself is of the type that can be controlled through an electrical signal. As for the self-locking device 4 adopting a traditional mechanical lock, the locked state of the self-locking device 4 can also be manually released after the sealing window 2 is closed.

Further optionally, the sealing window 2 may be configured as including at least two sealing plates, and the opening and closed states of each sealing plate are controlled independently by the automatic switching device 5. The usage of double-layered sealing plates independent from each other can further avoid sealing leakage due to the failure of one of the sealing plates.

In a word, the clean room provided in the embodiments of the present application replaces traditional self-contained clean room with a modular approach, and can realize rapid disassembly and relocation when the production line needs to be changed. Therefore, compared with the prior art, the clean room system of the present application involves better convenience, reliability and sealing stability.

### Second Embodiment

The second embodiment of the present application is further improved on the basis of the clean room module 100 of the first embodiment. In this embodiment, referring to FIGS. 3 to 6, the self-locking device 4 includes a first locking part 41, which is arranged in pair with a second locking part of the self-locking device of another clean room module, so as to achieve locking when the two are in contact.

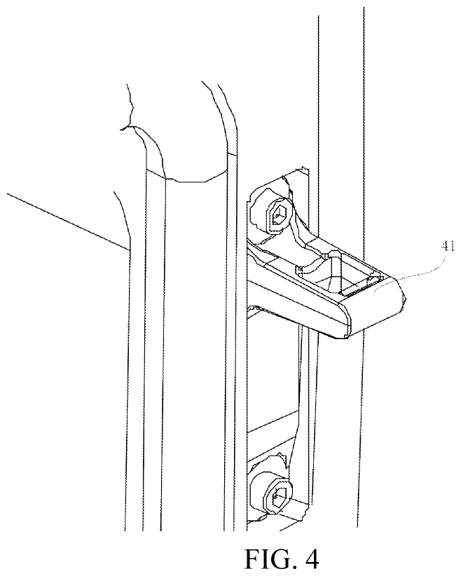

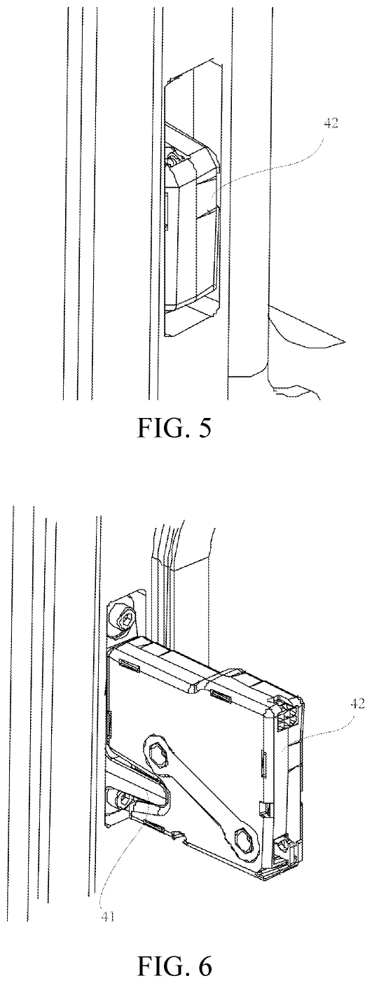

Optionally, referring to FIGS. 4 and 5, the first locking part 41 may include an outwardly protruding striker for connecting and locking with an electronic lock contained in the second locking part 42 of another clean room module 100. The locked state of the two can be seen in FIG. 6. Of course, the first locking part 41 may instead include an electronic lock for connection and locking with an outwardly protruding striker contained in the second locking part 42 of another clean room module 100. The striker-type electronic lock can provide a stable locking effect with a simple structure, and has the advantage of low costs.

When the first locking part 41 and second locking part 42 are arranged in pairs, the clean room modules 100 can be assembled in pairs. When it is necessary to assemble more clean room modules 100, in order to improve the convenience of assembly, optionally referring to FIG. 3, the self-locking device 4 may include a third locking part 43, which is arranged in pair with a fourth locking part in the self-locking device of another clean room module, so as to achieve locking when the two are in contact. Herein, the first locking part 41 and the third locking part 43 are also matched as a pair. Furthermore, the respective locking parts of the self-locking device 4 may be distributed on the housing 1 in a symmetrical manner. Since the first locking part 41 and the third locking part 43 are also matched as a pair, for a plurality of clean room modules 100, any two clean room modules 100 can be paired with each other.

Accordingly, it is also possible to provide a sealing window 2 around the housing 1, and to provide multiple sets of automatic switching devices 5 and multiple sets of self-locking devices 4 to further improve the convenience of assembly.

### Third Embodiment

The third embodiment of the present application is further improved on the basis of the clean room module 100 of the first or second embodiment. In this embodiment, the first locking part 41 includes a magnetic attraction piece for connecting and locking with the magnetic attraction piece contained in the second locking part 42 of another clean room module 100.

When the magnetic attraction is used for connecting and locking, an electromagnet can be utilize to control the locking operation of the self-locking device 4.

Herein, for the first locking part 41, the magnetic attraction piece may be an electromagnet; and for the second locking part 42, the magnetic attraction piece may be an electromagnet or a metal iron. When the second locking part 42 is an electromagnet and the locked state of the self-locking device 4 needs to be released, magnetic levels of the two electromagnets can be set the same to form a repulsive force there-between, so that the two clean room modules 100 would bounce apart.

In addition, it is to be noted that when the electromagnet is in contact with a metal iron or other electromagnets, it can generate a conduction by itself, so it can be used as a locking signal generator. In other words, a signal transmitter for the locking signal can be arranged in the clean room module 100, and the transmitting circuit where the signal transmitter is positioned is in a state disconnected and to-be-activated by default. This disconnected and to-be-activated state includes, but is not limited to, setting a transmitting circuit in one of the clean room modules 100, and setting a battery and remaining circuits in another clean room module 100.

When two clean room modules 100 are approaching, the self-locking devices 4 are also relatively close to each other. After the electromagnet is activated, the two clean room modules 100 can be locked together. At this time, since the circuits of two clean room modules 100 are connected and conducted with each other, the signal transmitter can be powered on and send a locking signal.

Compared with the setting of additional sensors to monitor whether the clean room module 100 has reached a locked state, the present application directly connects the signal transmitter to the first locking part 41 and second locking part 42, which significantly simplifies the circuit structure and reduces the costs, and plays a role of preventing misjudgment.

While the present application has been described in detail with reference to only a limited number of embodiments, it is understood that the application is not limited to such disclosed embodiments. Rather, the application can be modified to incorporate any number of variations, alterations, substitutions or equivalent arrangements which are heretofore not described, but are commensurate with the spirit and scope of the application. Further, while various embodiments of the application have been described, it is understood that each aspect of the application may include only some of the described embodiments. Generally, the application is not limited by the foregoing description, but is only limited by the scope of the appended claims.

1. A clean room module comprising:
a housing provided with a sealing window, around which is arranged a seal;
an automatic switching device connected with the sealing window to control opening and closing of the sealing window;
a self-locking device provided at the housing and located on the side of the sealing window, wherein the self-locking device can be connected to and locked with a self-locking device of another clean room module from outside,
when the self-locking device is locked, the seal forms a sealed contact with a seal of another clean room module;
when the self-locking device is locked, the clean room module sends a locking signal to a controller, and the automatic switching device opens the sealing window responsive to a window opening signal generated by the controller according to the locking signal.

2. The clean room module according to claim 1, wherein the self-locking device comprises a first locking part, which is arranged in pair with a second locking part in the self-locking device of another clean room module, so as to achieve locking when the two are in contact.

3. The clean room module according to claim 2, wherein,
the first locking part comprises an outwardly protruding striker for connecting and locking with an electronic lock contained in the second locking part of another clean room module.

4. The clean room module according to claim 2, wherein the first locking part comprises a magnetic attraction piece for connecting and locking with a magnetic attraction piece contained in the second locking part of another clean room module.

5. The clean room module according to claim 2, wherein
the self-locking device comprises a third locking part, which is arranged in pair with a fourth locking part in the self-locking device of another clean room module, so as to achieve locking when the two are in contact;
wherein the first locking part and the third locking part are also matched as a pair.

6. The clean room module according to claim 2, wherein the respective locking parts of the self-locking device are distributed in a symmetrical manner on the housing.

7. The clean room module according to claim 1, wherein the self-locking device is provided in an area between the sealing window and the seal.

8. The clean room module according to claim 1, wherein the sealing window comprises at least two sealing plates, the opening and closed state of each sealing plate being independently controlled by the automatic switching device.

9. A clean room system comprising a plurality of the clean room modules according to claim 1, the respective clean room modules being connectable to each other via the automatic switching device.

10. A self-locking method of clean room module, the method comprising the steps of:
sending a locking signal to a controller, responsive to a locking operation of a self-locking device of the clean room module with a self-locking device of another clean room module from outside;
opening a sealing window of the clean room module with an automatic switching device, responsive to a window opening signal generated by the controller according to the locking signal.

11. The clean room module according to claim 2, wherein,
the first locking part comprises an electronic lock for connecting and locking with an outwardly protruding striker contained in the second locking part of another clean room module.

12. The clean room module according to claim 5, wherein the respective locking parts of the self-locking device are distributed in a symmetrical manner on the housing.
